(19) United States
(12) Patent Application Publication
(10) Pub. No.: US 2018/0121982 A1
(43) Pub. Date: May 3, 2018

(54) SAFE ONLINE TRANSACTION METHOD, ONLINE TRANSACTION PLATFORM, AND SERVICE FEE PLATFORM

(71) Applicants: ZHEJIANG GEELY HOLDING GROUP CO., LTD, Hangzhou (CN); ZHEJIANG GEELY AUTOMOBILE RESEARCH INSTITUTE CO., LTD, Taizhou (CN)

(72) Inventor: Shufu LI, Hangzhou (CN)

(21) Appl. No.: 15/563,897

(22) PCT Filed: Aug. 14, 2015
(86) PCT No.: PCT/CN2015/087028

§ 371 Date: Oct. 2, 2017

(30) Foreign Application Priority Data
Apr. 2, 2015 (CN) 201510154555.6

(51) Int. Cl. G06Q 30/06; G06Q 20/38; G06Q 20/12

(52) U.S. Cl. CPC G06Q 30/0617; G06Q 20/12; G06Q 20/382

(57) ABSTRACT

A secure network transaction method, network transaction platform, and service fee platform. The method comprises: when a buyer and a seller conduct a network transaction via a network transaction platform, the network transaction platform deducting a part of fee from a transaction fund of the network transaction as a service fee of the network transaction, transferring the remaining transaction fund after the service fee has been deducted to a seller account, and transferring the service fee of the network transaction to a service fee platform, service fees of all network transactions conducted on the network transaction platform constituting a compensation capital pool on the service platform; and, when the buyer initiates a claim for compensation with regard to the network transaction, the service fee platform extracting a compensation capital of the network transaction from the compensation capital pool and transferring same to a buyer account. The difficulty of rights protection of a consumer with regard to a shop can be reduced when a transaction dispute occurs between the consumer and the shop, which better ensures the rights and interests of the consumer.

The present application claims priority to Chinese Patent Application No. 201510154555.6, filed with the Chinese Patent Office on 2 Apr. 2015 and entitled “Network transaction system and transaction platform server for network transaction platform”, which is incorporated herein by reference in its entirety.

### TECHNICAL FIELD

The present invention relates to the field of computer applications, and in particular to a secure network transaction method, network transaction platform and service fee platform.

### BACKGROUND OF THE INVENTION

Various network transaction platforms exist at present, such as Taobao, Amazon, eBay, etc., and more and more consumers are keen to shop via the network transaction platforms. Compared to physical shops, shops on the network transaction platform generally are able to provide more competitive commodity prices and more convenient shopping experience. However, shopping on the network transaction platforms is clearly more likely to face shopping risks such as fake or fraud and the like.

On some network transaction platforms, various shops are sales subjects (or referred to as sellers), and the network transaction platforms only provide a unified platform for the various shops to perform transactions with consumers (or referred to as buyers), and manage the normal operation of the platform. When a transaction dispute occurs between a consumer and a shop on the network transaction platform, the consumer generally can only initiate a rights protection action with regard to the shop directly in practice.

However, it is well known that most shops in the network transaction platform are small-scale shops, which have the characteristics of short survival time, low compensation capability, etc. Therefore, in general, it is relatively difficult for consumers to perform rights protection with regard to shops. In addition, although operators of network transaction platforms are generally large-scale enterprises having abundant financial resources and are relatively stable, the network transaction platforms are not sellers in transactions, and therefore consumers generally are not able to initiate rights protection actions with regard to the network transaction platforms directly.

### SUMMARY OF THE INVENTION

In order to solve the technical problems above, the embodiments of the present invention provide a secure network transaction method, network transaction platform and service fee platform, so that the difficulty of rights protection of a consumer with regard to a shop can be reduced when a transaction dispute occurs between the consumer and the shop, which better ensures the rights and interests of the consumer.

According to a first aspect of the embodiments of the present invention, a secure network transaction method is disclosed, comprising:

when a buyer and a seller conduct a network transaction via a network transaction platform, the network transaction platform deducting a part of fee from a transaction fund of the network transaction as a service fee of the network transaction, transferring the remaining transaction fund after the service fee has been deducted to a seller account, and transferring the service fee of the network transaction to a service fee platform; service fees of all network transactions conducted on the network transaction platform constituting a compensation capital pool on the service fee platform; and

when the buyer initiates a claim for compensation with regard to the network transaction, the service fee platform extracting a compensation capital of the network transaction from the compensation capital pool and transferring same to a buyer account.

According to a second aspect of the embodiments of the present invention, a network transaction platform is disclosed, the network transaction platform comprising a first processor,

the first processor being configured to: when a buyer and a seller conduct a network transaction via the network transaction platform, deduct a part of fee from a transaction fund of the network transaction as a service fee of the network transaction, transfer the remaining transaction fund after the service fee has been deducted to a seller account, and transfer the service fee of the network transaction to a service fee platform, service fees of all network transactions conducted on the network transaction platform constituting a compensation capital pool on the service fee platform, wherein when the buyer initiates a claim for compensation with regard to the network transaction, a part of capital in the compensation capital pool is transferred to a buyer account from the service fee platform as a compensation capital of the network transaction.

According to a third aspect of the embodiments of the present invention, a service fee platform is disclosed, the service fee platform comprising a second processor, the second processor being configured to: store service fees of all network transactions transferred via the network transaction platform to constitute a compensation capital pool; and when the buyer initiates a claim for compensation with regard to a network transaction, extract a compensation capital of the network transaction from the compensation capital pool and transfer same to a buyer account, wherein the service fee of the network transaction is a part of fee deducted from a transaction fund of the network transaction, and the remaining transaction fund after the service fee has been deducted is transferred to a seller account.

In the technical solutions of the present invention, the service fee platform is able to provide a rights protection channel and compensation for the buyer on the network transaction platform, and once an infringement behavior occurs, the buyer may also obtain a compensation capital equal to or greater than the transaction fund from the service fee platform without claiming for compensation from the seller, which is helpful to improve the convenience and reliability of rights protection and compensation of the buyer. In addition, the network transaction platform in the present invention is different from means of consumption insurance, etc. on other network transaction platforms, and the means of consumption insurance, etc. need the buyer to additionally pay an insurance fee, which increases a shopping burden of the buyer. However, the present invention does not need the buyer to additionally pay the insurance fee, but deducts a part of service fee from the transaction fund of each network transaction as a source of compensation capital. In addition, the service fee platform in the present invention is also different from a self-operation mode of other network transaction platforms. In the self-operation mode, the network transaction platform needs to bear the liability for breach of contract, while in fact the difficulty for the buyer to fight against a large-scale network transaction platform and perform rights protection is relatively large. The service fee platform of the present invention may be managed by an operator different from that of the network transaction platform, and provide safeguard for the buyer as a fair third party, and the processing process is fair, open, effective and in time.

Furthermore, the present invention can achieve automation of signing an electronic protocol to the maximum degree, and can perform different processing procedures with regard to a new shop and an old shop. Moreover, when the network transaction platform signs the electronic protocol with a large number of shops, the signing time points may be dispersed according to the solution of the present invention, which avoids processing a large amount of data work within a short time by the network transaction platform, reduces an instantaneous load of the transaction platform server, and reduces the total data processing volume of the network transaction platform as much as possible.

### BRIEF DESCRIPTION OF THE DRAWINGS

In order to illustrate the technical solutions in the embodiments of the present invention or in the prior art more clearly, the accompanying drawings required for describing the embodiments are briefly introduced below. Apparently, the accompanying drawings in the following description show merely some embodiments of the present invention, and those of ordinary skills in the art may still derive other drawings from these accompanying drawings without creative efforts.

FIG. 1 illustratively shows an exemplary application scenario where an embodiment of the present invention may be implemented therein;

FIG. 2 shows a flowchart of a secure network transaction method according to an embodiment of the present invention;

FIG. 3 shows a signaling diagram of a secure network transaction method according to an embodiment of the present invention;

FIG. 4 shows a signaling diagram of a network transaction platform signing an electronic protocol with a client of a seller according to an embodiment of the present invention;

FIG. 5 shows a flowchart of a method for signing an electronic protocol according to an embodiment of the present invention;

FIG. 6 shows a structural block diagram of a network transaction platform according to an embodiment of the present invention;

FIG. 7 shows a structural block diagram of another network transaction platform according to an embodiment of the present invention; and

FIG. 8 shows a structural block diagram of a service fee platform according to an embodiment of the present invention.

### DETAILED DESCRIPTION OF THE INVENTION

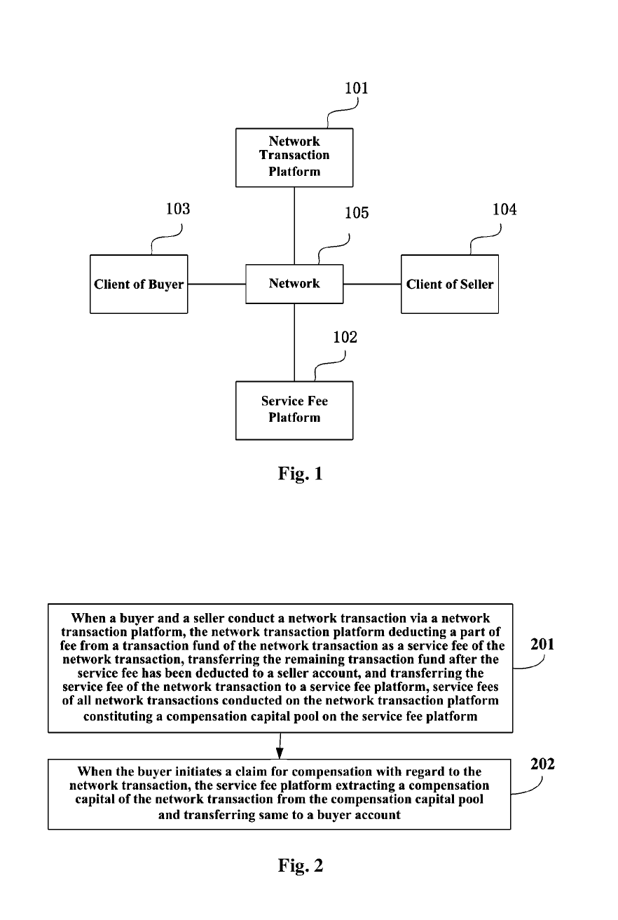

Please refer to FIG. 1. FIG. 1 illustratively shows an exemplary application scenario where an embodiment of the present invention may be implemented therein, wherein the scenario comprises a network transaction platform (or referred to as a network transaction server) 101, a service fee platform (or referred to as a service fee server) 102, a client 103 of a buyer and a client 104 of a seller, which interact with each other via a network 105 to complete a network transaction, wherein the network transaction platform 101 and the service fee platform 102 may be platforms independent from each other and managed by different operators.

### Method Embodiment

In conjunction with the application scenario shown in FIG. 1, please refer to FIG. 2. FIG. 2 shows a flowchart of a secure network transaction method according to an embodiment of the present invention, and the method, for example, may comprise the following steps:

S201: when a buyer and a seller conduct a network transaction via a network transaction platform, the network transaction platform deducting in advance a part of fee from a transaction fund of the network transaction as a service fee of the network transaction, transferring the remaining transaction fund after the service fee has been deducted to a seller account, and transferring the service fee of the network transaction to a service fee platform; service fees of all network transactions conducted on the network transaction platform constituting a compensation capital pool on the service fee platform; and

S202: when the buyer initiates a claim for compensation with regard to the network transaction, the service fee platform extracting a compensation capital of the network transaction from the compensation capital pool and transferring same to a buyer account.

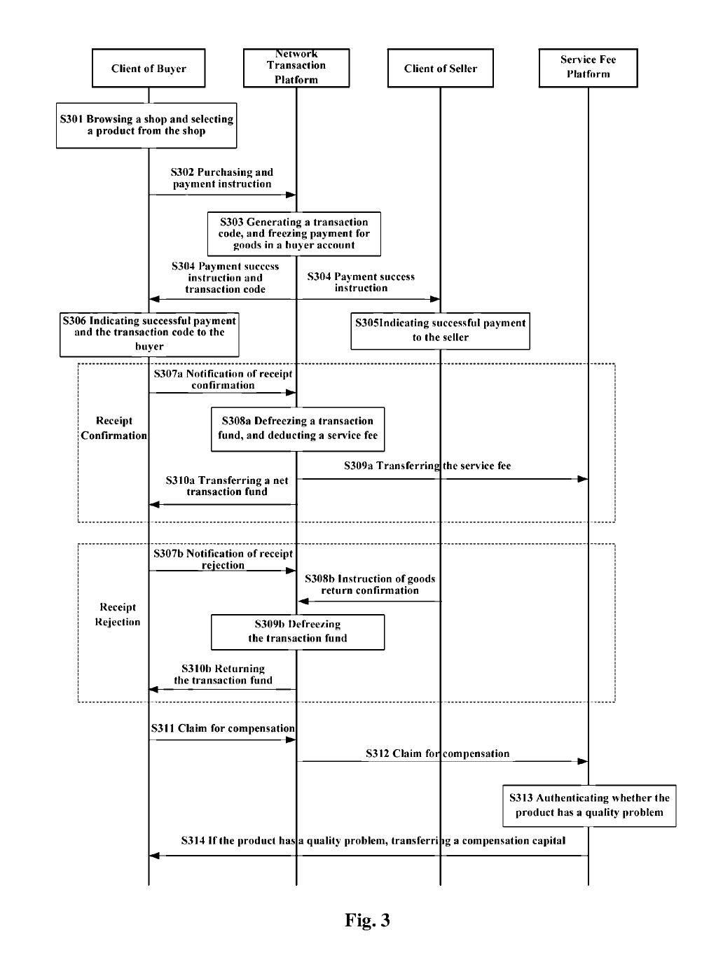

In order to more comprehensively illustrate the secure network transaction process of the present invention, please refer to FIG. 3. FIG. 3 shows a signaling diagram of a secure network transaction method according to an embodiment of the present invention, wherein the method comprises:

S301: a buyer browsing a shop on a network transaction platform via a client of the buyer and selecting a product from the shop;

S302: the client of the buyer initiating a purchasing and payment instruction with regard to the product selected by the buyer to the network transaction platform;

S303: the network transaction platform generating a transaction code for the network transaction according to the purchasing and payment instruction, and freezing payment for goods (i.e. a transaction fund of the network transaction) saved in a buyer account in advance;

S304: the network transaction platform sending out an instruction of successful payment to the client of the buyer and a client of a seller, and sending to out the transaction code of the network transaction to the client of the buyer;

S305: the client of the seller indicating successful payment to the seller according to the received instruction of successful payment for the seller to arrange delivery;

S306: the client of the buyer indicating successful payment and the transaction code of the network transaction to the buyer according to the received instruction of successful payment for the buyer to track the delivery progress on the client of the buyer at any time according to the transaction code and wait for receipt;

S307a: if the buyer confirms receipt after receiving the goods, the client of the buyer sending out a notification of receipt confirmation to the network transaction platform;

S308a: the network transaction platform defreezing the transaction fund of the network transaction, and deducting a part of fee from the transaction fund of the network transaction as a service fee of the network transaction;

S309a: the network transaction platform transferring the service fee of the network transaction to a service fee platform,

wherein the service fee platform counts and records service fee details of all sellers after receiving the service fee from the network transaction platform, and the service fee platform feeds back the above service fee details to the client of the corresponding seller periodically, and service fees of all network transactions constitute a compensation capital pool on the service fee platform;

S310a: the network transaction platform transferring the remaining transaction fund (or referred to as a net transaction fund) after the service fee has been deducted to a seller account, ending the transaction;

S307b: if the buyer rejects to receive goods due to various reasons after receiving the goods, the client of the buyer sending out a notification of receipt rejection to the network transaction platform, and the buyer arranging goods return;

S308b: after the seller receives the goods return of the buyer, the client of the seller sending out an instruction of goods return confirmation to the network transaction platform;

S309b: the network transaction platform defreezing the transaction fund of the network transaction;

S310b: the network transaction platform returning the transaction fund of the network transaction to the buyer account, ending the transaction;

S311: if the buyer finds that the product has a quality problem after using the purchased product, the client of the buyer initiating a claim for compensation to the network transaction platform;

S312: the network transaction platform forwarding the claim for compensation to the service fee platform for processing; and

certainly the client of the buyer being also able to directly send out the claim for compensation to the service fee platform;

S313: the service fee platform authenticating whether the product has a quality problem; and

S314: after confirming that the product has a quality problem, the service fee platform extracting a certain amount of compensation capital from the compensation capital pool and returning same to the buyer account.

Certainly, it needs to be noted that the amount of the compensation capital may be N times of the amount of the transaction fund of the network transaction, N being a positive integer.

In the present invention, before extracting a certain service fee from each transaction fund of the seller, the network transaction platform needs to sign a relevant electronic protocol with the client of the seller. The electronic protocol may comprise agreement relevant to the service fee, for example, agreeing terms and conditions of charging the seller for a service fee by the network transaction platform and the proportion of the service fee, etc.

The signing of the electronic protocol may be started by the network transaction platform, and may also be started by the client of the seller,

wherein when the signing of the electronic protocol is started by the network transaction platform, the network transaction platform and the client of the seller signing an electronic protocol comprises: the network transaction platform detecting whether same has signed an electronic protocol with an existing shop, and if not, generating an electronic protocol to be signed, and sending an electronic protocol signing request carrying the electronic protocol to be signed to the client of the seller corresponding to the shop; and the client of the seller sending an electronic protocol signing response representing whether the seller accepts the electronic protocol to the network transaction platform, wherein when the electronic protocol signing response represents that the seller accepts the electronic protocol, the network transaction platform deducts a part of fee from the transaction fund of the network transaction as the service fee of the network transaction.

The network transaction platform detecting whether same has signed an electronic protocol with an existing shop is: in response to an order initiated by the client of the buyer, the network transaction platform detecting whether same has signed an electronic protocol with a shop corresponding to the order.

The network transaction platform stores protocol signing state information, the protocol signing state information being divided into a signed state and an unsigned state for representing whether the network transaction platform has signed an electronic protocol with an existing shop; and the network transaction platform detecting whether same has signed an electronic protocol with an existing shop is: the network transaction platform detecting whether same has signed an electronic protocol with an existing shop according to the protocol signing state information.

The network transaction platform generates a protocol signing state flag corresponding to the protocol signing state information visible to the buyer on a page of a shop displayed to the client of the buyer, the protocol signing state flag being used for displaying to the buyer whether the shop has signed an electronic protocol with the network transaction platform.

When the signing of the electronic protocol is started by the client of the seller the network transaction platform and the client of the seller signing an electronic protocol comprises: the client of the seller generating a shop creation request according to an input of the seller and sending the shop creation request to the network transaction platform; the network transaction platform sending an electronic protocol signing request carrying the electronic protocol to be signed to the client of the seller; and the client of the seller sending an electronic protocol signing response representing whether the seller accepts the electronic protocol to the network transaction platform, wherein when the electronic protocol signing response represents that the seller accepts the electronic protocol, the network transaction platform deducts a part of fee from the transaction fund of the network transaction as the service fee of the network transaction.

When the electronic protocol signing response represents that the seller accepts the electronic protocol, the network transaction platform sets protocol signing state information about the shop of the seller as a signed state.

When the electronic protocol signing response represents that the seller rejects the electronic protocol, the network transaction platform terminates the signing of the electronic protocol.

Before the network transaction platform generates the electronic protocol to be signed, the network transaction platform acquires shop information about the shop of the seller, and detects whether the shop information is complete, wherein when the shop information is complete, the network transaction platform generates the electronic protocol to be signed.

When the shop information is incomplete, the network transaction platform sends a form filling request carrying an information collection form to the client of the seller; the client of the seller sends a form filling response to the network transaction platform, and the form filling response carries an information collection form where shop information has been filled; and the network transaction platform extracts the shop information from the information collection form and stores same on the network transaction platform.

When the shop information is complete, the network transaction platform detects whether the shop conforms to a signing requirement of signing an electronic protocol pre-determined by the network transaction platform according to the shop information, wherein when the shop conforms to the signing requirement of signing an electronic protocol pre-determined by the network transaction platform, the network transaction platform generates the electronic protocol to be signed.

When the shop does not conform to the signing requirement of signing an electronic protocol pre-determined by the network transaction platform, the network transaction platform terminates the signing of the electronic protocol.

At least one item of the shop information is a risk-related item relevant to a shop operation risk; and the network transaction platform detecting whether the shop conforms to a signing requirement of signing an electronic protocol pre-determined by the network transaction platform according to the shop information comprises: the network transaction platform utilizing the risk-related item to calculate a risk factor of the shop according to a pre-determined algorithm, comparing the risk factor of the shop with a pre-set risk threshold value, if the risk factor of the shop is greater than or equal to the pre-set risk threshold value, determining that the shop does not conform to the signing requirement of signing an electronic protocol pre-determined by the network transaction platform, and if the risk factor of the shop is smaller than the pre-set risk threshold value, determining that the shop conforms to the signing requirement of signing an electronic protocol pre-determined by the network transaction platform.

Pre-set risk coefficients and weights corresponding to all risk-related items are stored on the network transaction platform, and the risk factor is obtained through calculation of a risk coefficient and weight of the risk-related item in the shop information.

The network transaction platform deducting a part of fee from the transaction fund of the network transaction as the service fee of the network transaction comprises: the network transaction platform calculating the service fee of the network transaction according to a service fee proportion agreed with the seller, the service fee proportion being a proportion of the service fee to the transaction fund; and the network transaction platform deducting the service fee of the network transaction from the transaction fund of the network transaction, wherein the service fee proportion may be a fixed proportion. In an optional implementation of the present invention, the service fee proportion is 0%-8%. In a preferred implementation of the present invention, the service fee proportion is 3%.

The service fee proportion may also be obtained through calculation of the network transaction platform according to at least one service fee-related item relevant to calculating the service fee proportion in shop information about the seller. In an optional implementation of the present invention, the service fee proportion is inversely proportional to an accumulated transaction volume of the shop.

When the network transaction platform terminates the signing of the electronic protocol, if the signing of the electronic protocol is started by the client of the seller, the network transaction platform generates a shop creation response representing terminating the current signing of the electronic protocol, and sends the shop creation response to the client of the seller; and if the signing of the electronic protocol is started by the network transaction platform, the network transaction platform generates a transaction failure message representing terminating the order due to being unable to sign the electronic protocol, and sends the transaction failure message to the client of the seller.

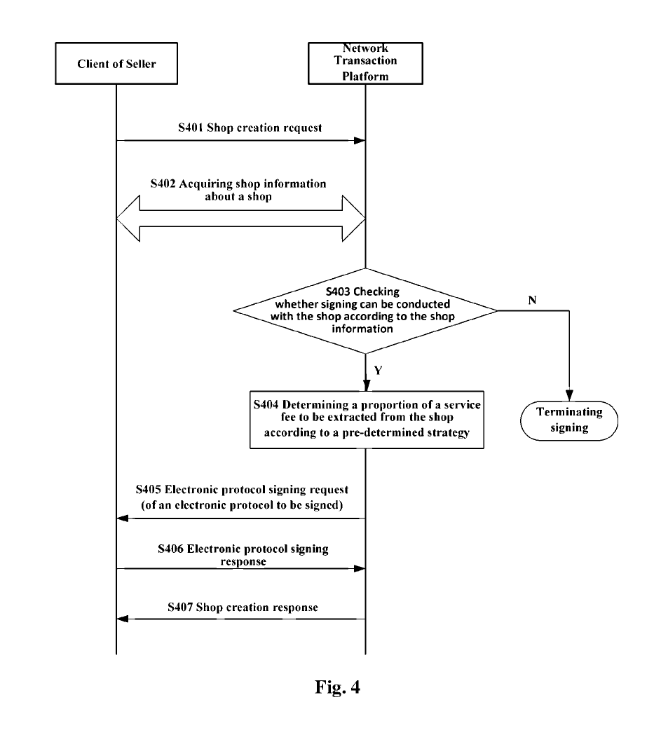

Please refer to FIG. 4. FIG. 4 shows a signaling diagram of a network transaction platform signing an electronic protocol with a client of a seller according to an embodiment of the present invention. In the procedure or the electronic protocol signing method shown in FIG. 4, the network transaction platform or the client of the seller may start the signing of the electronic protocol, for example, FIG. 4 shows an electronic protocol signing procedure taking the client of the seller starting the signing of the electronic protocol as an example, which specifically comprises:

S401: when a seller wants to create a new shop in the network transaction platform, a client of the seller generates a shop creation request according to an input of the seller, and sends the shop creation request to the network transaction platform to start the signing of an electronic protocol.

In addition to the case where the client of the seller may start the signing of the electronic protocol, the network transaction platform may also actively detect whether an electronic protocol has been signed between same and an existing shop, and the network transaction platform generates a protocol signing instruction in the case where no electronic protocol has been signed to start the signing of the electronic protocol for the shop.

It can be understood that in other implementations, with regard to an existing shop in the network transaction platform, the client of the seller may also start the signing of the electronic protocol. In one implementation, the client of the seller may generate a protocol signing request according to the input of the seller and send same to the network transaction platform to start the signing of the electronic protocol, which is similar to starting the signing of a protocol for a new shop, and therefore the protocol signing request may be processed basically the same as the shop creation request in the present invention.

In another implementation, the network transaction platform may monitor an order initiated by a buyer, and in response to the monitored order, detect whether an electronic protocol has been signed with a shop corresponding to the order. In this way, the detection for an electronic protocol with regard to a certain shop is triggered by an order relevant to the shop. In another word, only in the case where the shop possibly will have a transaction with the buyer, the network transaction platform detects whether an electronic protocol has been signed with the shop. With regard to some existing shops on the network transaction platform, although no electronic protocol has been signed, as long as there is no transaction, the network transaction platform may not start the signing of the electronic protocol. In this way, in one aspect, the time points for the network transaction platform to sign with a large number of shops are dispersed, which avoids processing a large amount of data work relevant to protocol signing within a short time by the network transaction platform, and reduces an instantaneous load of the network transaction platform. In another aspect, with regard to those shops with which no transaction will be generated subsequently, the signing of the electronic protocol will not be started, so that useless data processing is avoided, and the total data processing volume of the network transaction platform is reduced.

The monitoring by the network transaction platform for the order may be performed after the order has been submitted by the buyer but before being sent to the seller. After the order has been monitored, the network transaction platform may pause the processing procedure of the order and performs detection of the electronic protocol. In the case where the network transaction platform detects that the shop corresponding to the order has not signed the electronic protocol, the network transaction platform may suspend the subsequent procedure of the order and generate a signing request of the electronic protocol to start the signing of the electronic protocol for the shop corresponding to the order. In the case where the network transaction platform detects that the shop corresponding to the order has signed the electronic protocol, the subsequent procedure of the order may continue to be executed, for example, the order is sent to the seller so that the transaction between the buyer and the seller is conducted normally.

In one implementation, the network transaction platform may store corresponding protocol signing state information for each existing shop for representing whether the network transaction platform has signed the desired electronic protocol with the shop. The protocol signing state information may be divided into a signed state and an unsigned state. It will be seen hereafter that after the network transaction platform and the shop have completed the signing of the electronic protocol, then the protocol signing state information corresponding to the shop may be set as a signed state. In this way, the network transaction platform may detect whether the electronic protocol has been signed according to the protocol signing state information about the shop.

Generally, the network transaction platform may store shop information about each shop, and the protocol signing state information may be stored in the network transaction platform as a part of content of the shop information.

S402: the network transaction platform acquires shop information about the shop.

For example, the required shop information may comprise: a seller name, a seller address, a registered capital of the seller, an account to be credited of the seller, selling goods categories and other required documentary evidences and so on. This step may be executed where the network transaction platform does not have the shop information about the shop, or be executed when the existing shop information is incomplete. For example, with regard to a shop to be created by the seller, the network transaction platform may not store any shop information about the shop. In other cases, the network transaction platform stores partial shop information about the shop, which is incomplete for achieving each step to be described below. Certainly, in the case where the network transaction platform has stored complete shop information, in particular for an existing shop, the step of acquiring shop information may be omitted.

When the network transaction platform acquires the shop information, an information collection form may be utilized to collect the shop information. The information collection form may be configured in advance by the network transaction platform according to shop information desired thereby, and the completeness of shop information may be ensured in this way.

In one implementation, if the client of the seller starts protocol signing, the network transaction platform may return a form filling request to the client of the seller in response to the shop creation request from the client of the seller, the form filling request carrying an information collection form to be filled. If the network transaction platform starts protocol signing, the network transaction platform may send the form filling request to the client of the seller in response to a protocol signing instruction generated within the network transaction platform. In another implementation, an information collection form which has not been filled may be provided in the client of the seller in advanced, and when the network transaction platform acquires the shop information, the network transaction platform may only send a form filling request to the client of the seller, the form filling request not carrying an information collection form to be filled.

The client of the seller may present, in response to the form filling request, the information collection form from the network transaction platform or provided in advance in the client of the seller for the seller to fill. After the seller fills the shop information in the information collection form by virtue of the client of the seller, the client of the seller sends the information collection form in which the shop information has been filled to the network transaction platform. Then, the network transaction platform extracts the shop information from the information collection form and stores the extracted shop information in the network transaction platform. If the information collection form is provided in the client of the seller in advance, for the purpose of convenience and efficiency improvement, the seller may send the information collection form together with the shop creation request to the network transaction platform after filling the shop information.

S403: the network transaction platform checks whether signing can be conducted with the shop according to the shop information, and if so, step 404 is entered, otherwise, the signing procedure is terminated.

In one implementation, the check may comprise detecting whether the shop information is complete for signing the electronic protocol. If the shop information is incomplete, in addition to terminating the signing procedure, step S402 described above may also be returned again to acquire the shop information again. For example, the network transaction platform may send the form filling request to the client of the seller so as to collect the shop information via the information collection form.

In addition, the check may further comprise detecting whether the shop conforms to a signing requirement of signing the electronic protocol pre-determined by the network transaction platform, wherein in one implementation, the signing requirement comprises risk assessment for the shop. For example, in the shop information acquired by the network transaction platform, one or more items therein may be (a) risk-related item(s) relevant to a shop operation risk. The network transaction platform may utilize the risk-related item(s) to calculate a risk factor of the shop according to a pre-determined algorithm, and compare the risk factor of the shop with a pre-determined risk threshold value. If the risk factor of the shop is greater than or equal to the risk threshold value, then the shop does not conform to the corresponding signing requirement, otherwise, the shop conforms to the corresponding signing requirement.

In order to calculate the risk factor of the shop, pre-set risk coefficients and weights corresponding to all risk-related items may be stored in the network transaction platform. In this way, the risk factor of the shop may be obtained through calculation according to the risk coefficients and weights of the risk-related items in the shop information. The risk-related items herein are used for evaluating the operation risk of the shop, which may, for example, comprise: a registered capital of the shop, operation time, selling goods categories, historical buyer comments, history and amount of claims for compensation, etc. The shop can be automatically checked by this means to reduce human workload. Certainly, auxiliary manual check may be added on the basis of automatic check. In particular, the history and amount of claims for compensation may be provided for the network transaction platform by the service fee platform.

When the shop does not conform to the signing requirement, and the signing of the electronic protocol is started by the client of the seller, for example, via a shop creation request, the network transaction platform may generate a shop creation reject response and send same to the client of the seller to represent terminating the currently conducted signing of the electronic protocol for the seller, and reject the seller to create a shop. When the shop does not conform to the signing requirement, and the signing of the electronic protocol is started by the network transaction platform, for example, via a protocol signing instruction, since the order submitted by the buyer to the shop is suspended at the moment, the network transaction platform may generate a transaction failure message and send same to the client of the seller to represent terminating the order because the electronic protocol cannot be signed for the seller.

In the present invention, with regard to a shop of which the electronic protocol has been signed, later check may also be conducted thereon, the check comprising detecting whether the shop conforms to a culling standard pre-determined by the network transaction platform. For example, if a show has a relatively high amount of claims for compensation and more poor historical records, the shop may reach a standard of being culled out by the network transaction platform due to an integrity problem, and at this time a revocation procedure of revoking the shop from the network transaction platform may then be started. In one implementation, the network transaction platform may send an instruction of terminating the current cooperation relationship to the client of the seller that the electronic protocol has been signed, and publish information about sellers who have been culled out on the network transaction platform to achieve the purpose of stopping and eliminating fake and shoddy products on the platform, and make consumers aware of information about sellers who manufacture fake and shoddy products.

S404: after the shop check has been passed, the network transaction platform determines a proportion of a service fee to be extracted from the shop according to a pre-determined strategy.

In one implementation, the pre-determined strategy may be setting the service fee proportion as a fixed proportion, and the fixed proportion is set by the network transaction platform. Exemplarily, the fixed proportion may be selected between 1%-5%, and more specifically, the fixed proportion may be 3%.

In another implementation, the pre-determined strategy may be calculating to obtain the proportion of the service fee according to a pre-determined algorithm based on one or more service fee-related items (i.e. items relevant to calculating the proportion of the service fee) in the shop information. For example, service fee coefficients and weights corresponding to various service fee-related items are stored in the network transaction platform, and the proportion of the service fee is obtained through calculation according to the service fee coefficients and weights. It needs to be emphasized on that the service fee-related items are used for determining the proportion of the service fee, which, for example, may comprise: a registered capital of the shop, selling goods categories and the risk factor obtained through calculation above, etc. The proportion of the service fee may be automatically calculated by this means to reduce human workload. Certainly, auxiliary manual check may be added on the basis of automatic calculation.

S405: after the proportion of the service fee is determined, the network transaction platform sends an electronic protocol signing request carrying the electronic protocol to be signed to the client of the seller.

In one implementation, the electronic protocol to be signed may be generated via the network transaction platform by loading the proportion of the service fee and other information such as a seller name, a seller address, etc. on a pre-set protocol template. The pre-set protocol template may have corresponding terms and conditions for agreeing that the network transaction platform charges the service fee from the shop.

S406: the client of the seller sends an electronic protocol signing response representing whether the seller accepts the electronic protocol to the network transaction platform,

wherein the seller may input an instruction regarding whether to accept the electronic protocol at the client of the seller after reading the electronic protocol from the network transaction platform by virtue of the client of the seller, and the client of the seller generates the electronic protocol signing response according to the instruction and returns the electronic protocol signing response to the network transaction platform.

S407: the network transaction platform sends a shop creation response to the client of the seller depending on whether the seller accepts the electronic protocol.

When the seller rejects accepting the electronic protocol, the network transaction platform terminates the signing. Specifically, when the seller rejects accepting the electronic protocol, and the signing of the electronic protocol is started by the client of the seller, for example, via a shop creation request, the network transaction platform generates a shop creation reject response and sends same to the client of the seller to represent terminating the currently conducted signing of the electronic protocol for the seller, and rejects the seller to create a shop. On the contrary, when the seller accepts the electronic protocol, and the signing of the electronic protocol is started by the client of the seller, for example, via a shop creation request, the network transaction platform generates a shop creation allowing response and sends same to the client of the seller to represent continuing the currently conducted signing of the electronic protocol for the seller, and allows the seller to create a shop.

When the seller rejects accepting the electronic protocol, and the signing of the electronic protocol is started by the network transaction platform, for example, via a protocol signing instruction, since the order submitted by the buyer to the shop is suspended at the moment, the network transaction platform generates a transaction failure message and sends same to the client of the seller to represent terminating the order because the electronic protocol cannot be signed for the seller. On the contrary, when the seller accepts the electronic protocol, and the signing of the electronic protocol is started by the network transaction platform, for example, via a protocol signing instruction, the network transaction platform generates a transaction success message and sends same to the client of the seller to represent continuing the order because the electronic protocol can be signed for the seller.

When the seller accepts the electronic protocol, and the signing of the electronic protocol is started by the client of the seller, for example, via a shop creation request, the network transaction platform may further send information, such as a shop registration number and a shop network address, etc. corresponding to the shop to the client of the seller, representing that the network transaction platform has formed a cooperation relationship with the seller, and the seller may present and sell relevant products on the platform.

As described previously, the protocol signing state information may be used to represent whether the network transaction platform has signed the electronic protocol with the shop. In this way, after step 406, the network transaction platform may set the protocol signing state information about the corresponding shop as a signed state or an unsigned state.

In addition, the network transaction platform may further generate a protocol signing state flag corresponding to the protocol signing state information visible to the buyer in a shop display page, so that the buyer recognizes whether the shop is a shop which has signed the electronic protocol with the network transaction platform via the protocol signing state flag on the shop display page, so as to further determine the credit rating of the shop.

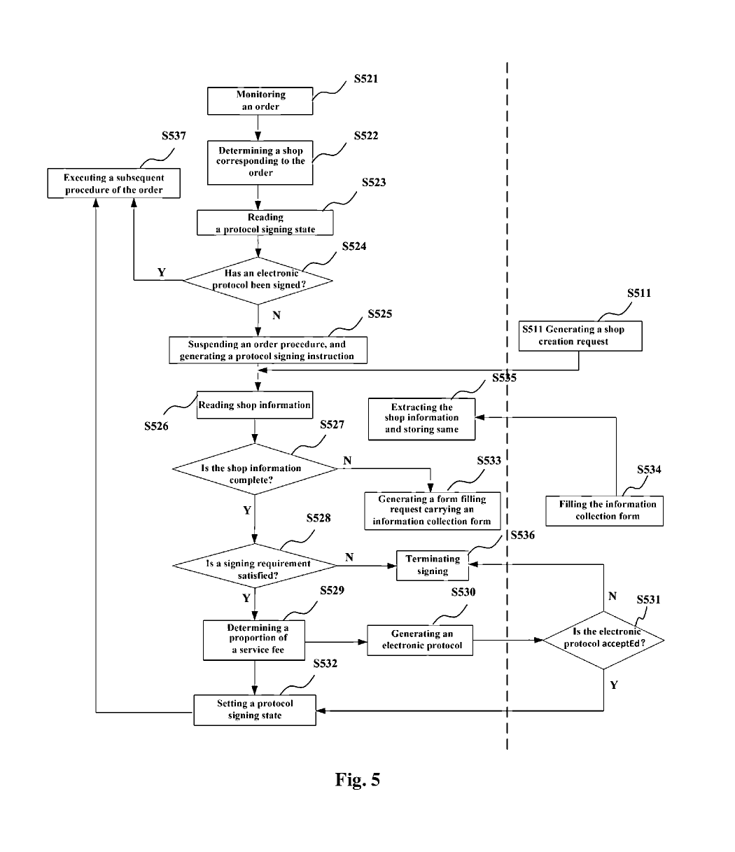

The method for signing an electronic protocol shown in FIG. 5 is a more specific implementation, wherein FIG. 5 draws a vertical dashed line, the left side of the dashed line represents an action executed by the network transaction platform, and the right side of the dashed line represents an action executed by the client of the seller.

As shown in FIG. 5, the procedure is started by the network transaction platform at S521-S525. In S521-S525, the network transaction platform actively detects whether a desired electronic protocol has been signed between same and an existing shop, and the network transaction platform generates a protocol signing instruction in the case where the electronic protocol has not been signed to start the signing of the electronic protocol for the shop. The method specifically comprises:

S521: the network transaction platform monitors an order initiated by a buyer.

As described above, the monitoring by the network transaction platform for the order may be performed after the order has been submitted by the buyer but before being sent to the seller.

S522: in response to the monitored order, the network transaction platform determines a shop corresponding to the order according to information about the order.

S523: the network transaction platform reads protocol signing state information about the shop corresponding to the order from stored shop information.

S524: the network transaction platform determines whether an electronic protocol has been signed with the shop corresponding to the order according to the protocol signing state information, and if so, S537 is entered, otherwise, S525 is entered.

S525: the network transaction platform suspends the subsequent procedure of the order and generates a protocol signing instruction to start the signing of the electronic protocol for the shop corresponding to the order.

S526: the network transaction platform reads shop information about the shop corresponding to the order from the stored shop information for a subsequent detection process.

S527: the network transaction platform detects whether the shop information is complete for signing the electronic protocol, and if so, S528 is entered, otherwise, S533 is entered.

S528: the network transaction platform detects whether the shop corresponding to the order conforms to a signing requirement of signing the electronic protocol pre-determined by the network transaction platform, and if so, S529 is entered, otherwise, S536 is entered.

S529: the network transaction platform determines a proportion of a service fee to be charged from the shop corresponding to the order according to a pre-determined strategy.

S530: the network transaction platform generates a required electronic protocol by loading the proportion of the service fee on a pre-set protocol template, and sends same to a client of the seller.

The pre-set protocol template may have relevant terms and conditions for agreeing that the network transaction platform extracts the service fee from the shop.

S531: the client of the seller determines whether to accept the electronic protocol, and if so, S532 is entered, otherwise, S536 is entered.

S532: the network transaction platform sets a protocol signing state, and S537 is entered.

S533: the network transaction platform generates a form filling request carrying an information collection form, and sends the form filling request to the client of the seller.

S534: the client of the seller displays the information collection form to the seller for the seller to fill same, and returns the information collection form in which the shop information has been filled to the network transaction platform.

S535: the network transaction platform extracts the shop information from the information collection form and stores same, and the procedure ends.

S536: the network transaction platform terminates the signing flow, and the procedure ends.

S537: the network transaction platform executes a subsequent procedure of the order.

For example, in the subsequent procedure, the network transaction platform sends the order to the seller, so that the transaction between the buyer and the seller is conducted normally.

The above procedure may also be started by the client of the seller at S511, that is, in S511, when the seller wants to create a new shop in the network transaction platform, the client of the seller generates a shop creation request according to an input of the seller, and sends same to the network transaction platform to start the signing of an electronic protocol to enter S526.

In the technical solutions of the present invention, the service fee platform is able to provide a rights protection channel and compensation for the buyer on the network transaction platform, and once an infringement behavior occurs, the buyer may also obtain a compensation capital equal to or greater than the transaction fund from the service fee platform without claiming for compensation from the seller, which is helpful to improve the convenience and reliability of rights protection and compensation of the buyer. In addition, the network transaction platform in the present invention is different from means of consumption insurance, etc. on other network transaction platforms, and the means of consumption insurance, etc. need the buyer to additionally pay an insurance fee, which increases a shopping burden of the buyer. However, the present invention does not need the buyer to additionally pay the insurance fee, but deducts a part of service fee from the transaction fund of each network transaction as a source of compensation capital. In addition, the service fee platform in the present invention is also different from a self-operation mode of other network transaction platforms. In the self-operation mode, the network transaction platform needs to bear the liability for breach of contract, while in fact the difficulty for the buyer to fight against a large-scale network transaction platform and perform rights protection is relatively large. The service fee platform of the present invention may be managed by an operator different from that of the network transaction platform, and provide safeguard for the buyer as a fair third party, and the processing process is fair, open, effective and in time.

Furthermore, the present invention can achieve automation of signing an electronic protocol to the maximum degree, and can perform different processing procedures with regard to a new shop and an old shop. Moreover, when the network transaction platform signs the electronic protocol with a large number of shops, the signing time points may be dispersed according to the solution of the present invention, which avoids processing a large amount of data work within a short time by the network transaction platform, reduces an instantaneous load of the transaction platform server, and reduces the total data processing volume of the network transaction platform as much as possible.

### Apparatus Embodiment

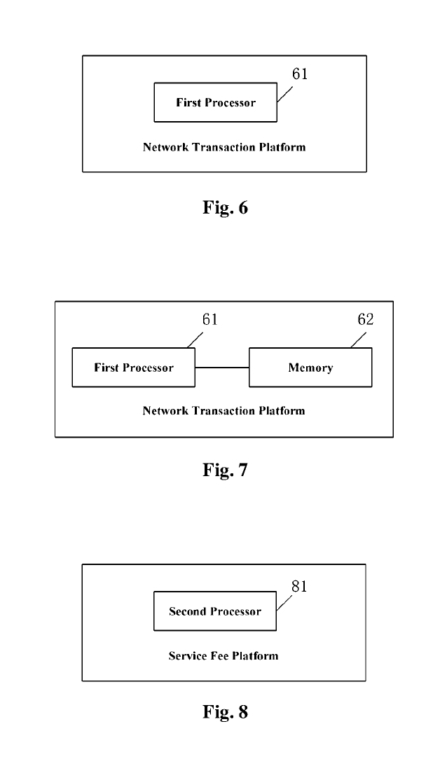

In addition to providing a secure network transaction method, the embodiments of the present invention further provides a network transaction platform. Please refer to FIG. 6. FIG. 6 shows a structural block diagram of a network transaction platform according to an embodiment of the present invention. The network transaction platform 60 comprises a first processor 61; and

the first processor 61 is configured to: when a buyer and a seller conduct a network transaction via the network transaction platform, deduct a part of fee from a transaction fund of the network transaction as a service fee of the network transaction, transfer the remaining transaction fund after the service fee has been deducted to a seller account, and transfer the service fee of the network transaction to a service fee platform, service fees of all network transactions conducted on the network transaction platform constituting a compensation capital pool on the service fee platform, wherein when the buyer initiates a claim for compensation with regard to the network transaction, a part of capital in the compensation capital pool is transferred to a buyer account from the service fee platform as a compensation capital of the network transaction.

In one optional implementation of the present invention, the first processor 61 is further configured to: before deducting a part of fee from a transaction fund of the network transaction as a service fee of the network transaction, sign an electronic protocol with a client of the seller, wherein the electronic protocol comprises agreement relevant to the service fee.

In another optional implementation of the present invention, the signing of the electronic protocol is started by the network transaction platform or the client of the seller.

In another optional implementation of the present invention, when the signing of the electronic protocol is started by the network transaction platform, the first processor 61 is specifically configured to: detect whether the network transaction platform has signed an electronic protocol with an existing shop, and if not, generating an electronic protocol to be signed, and sending an electronic protocol signing request carrying the electronic protocol to be signed to the client of the seller to which the shop belongs; and receive an electronic protocol signing response representing whether the seller accepts the electronic protocol sent by the client of the seller, wherein when the electronic protocol signing response represents that the seller accepts the electronic protocol, a part of fee is deducted from the transaction fund of the network transaction as the service fee of the network transaction.

In another optional implementation of the present invention, when the signing of the electronic protocol is started by the network transaction platform, the first processor 61 is specifically configured to: in response to an order initiated by a client of the buyer, detect whether the network transaction platform has signed an electronic protocol with an existing shop, and if not, generating an electronic protocol to be signed, and sending an electronic protocol signing request carrying the electronic protocol to be signed to the client of the seller to which the shop belongs; and receive an electronic protocol signing response representing whether the seller accepts the electronic protocol sent by the client of the seller, wherein when the electronic protocol signing response represents that the seller accepts the electronic protocol, a part of fee is deducted from the transaction fund of the network transaction as the service fee of the network transaction.

In another optional implementation of the present invention, as shown in FIG. 7, the network transaction platform 60 further comprises a memory (or storage) 62, the memory 62 being configured to: store protocol signing state information, the protocol signing state information being divided into a signed state and an unsigned state for representing whether the network transaction platform has signed an electronic protocol with an existing shop; and

the first processor 61 being specifically configured to: detect whether same has signed an electronic protocol with an existing shop according to the protocol signing state information.

In another optional implementation of the present invention, the first processor 61 is further configured to: generate a protocol signing state flag corresponding to the protocol signing state information visible to the buyer on a page of a shop displayed to the client of the buyer, the protocol signing state flag being used for displaying to the buyer whether the shop has signed an electronic protocol with the network transaction platform.

In another optional implementation of the present invention, when the signing of the electronic protocol is started by the client of the seller, the first processor 61 is specifically configured to: in response to the shop creation request sent by the client of the seller, send an electronic protocol signing request carrying the electronic protocol to be signed to the client of the seller; and receive an electronic protocol signing response representing whether the seller accepts the electronic protocol sent by the client of the seller, wherein when the electronic protocol signing response represents that the seller accepts the electronic protocol, a part of fee is deducted from the transaction fund of the network transaction as the service fee of the network transaction.

In another optional implementation of the present invention, the first processor 61 is further configured to: when the electronic protocol signing response represents that the seller accepts the electronic protocol, set protocol signing state information about the shop of the seller as a signed state.

In another optional implementation of the present invention, the first processor 61 is further configured to: when the electronic protocol signing response represents that the seller rejects the electronic protocol, the network transaction platform terminating the signing of the electronic protocol.

In another optional implementation of the present invention, the first processor 61 is further configured to: before the electronic protocol to be signed is generated, acquire shop information about the shop of the seller, and detect whether the shop information is complete, wherein when the shop information is complete, the electronic protocol to be signed is generated.

In another optional implementation of the present invention, the first processor 61 is further configured to: when the shop information is incomplete, send a form filling request carrying an information collection form to the client of the seller; receive a form filling response sent by the client of the seller, the form filling response carrying an information collection form where shop information has been filled; and extract the shop information from the information collection form and store same on the network transaction platform.

In another optional implementation of the present invention, the first processor 61 is further configured to: when the shop information is complete, detect whether the shop conforms to a signing requirement of signing an electronic protocol pre-determined by the network transaction platform according to the shop information, wherein when the shop conforms to the signing requirement of signing an electronic protocol pre-determined by the network transaction platform, the electronic protocol to be signed is generated.

In another optional implementation of the present invention, the first processor 61 is further configured to: when the shop does not conform to the signing requirement of signing an electronic protocol pre-determined by the network transaction platform, terminate the signing of the electronic protocol.

In another optional implementation of the present invention, at least one item of the shop information is a risk-related item relevant to a shop operation risk; and

the first processor 61 is specifically configured to: utilize the risk-related item to calculate a risk factor of the shop according to a pre-determined algorithm, compare the risk factor of the shop with a pre-set risk threshold value, if the risk factor of the shop is greater than or equal to the pre-set risk threshold value, determine that the shop does not conform to the signing requirement of signing an electronic protocol pre-determined by the network transaction platform, and if the risk factor of the shop is smaller than the pre-set risk threshold value, determine that the shop conforms to the signing requirement of signing an electronic protocol pre-determined by the network transaction platform.

In another optional implementation of the present invention, the memory 62 is further configured to: store pre-set risk coefficients and weights corresponding to all risk-related items, the risk factor being obtained through calculation of a risk coefficient and weight of the risk-related item in the shop information.

In another optional implementation of the present invention, the first processor 61 is specifically configured to: calculate the service fee of the network transaction according to a service fee proportion agreed with the seller, the service fee proportion being a proportion of the service fee to the transaction fund; and deduct the service fee of the network transaction from the transaction fund of the network transaction.

In another implementation of the present invention, the service fee proportion is a fixed proportion.

In another optional implementation of the present invention, the service fee proportion is 0%-8%.

In another optional implementation of the present invention, the service fee proportion is 3%.

In another optional implementation of the present invention, the service fee proportion is obtained through calculation of the network transaction platform according to at least one service fee-related item relevant to calculating the service fee proportion in shop information.

In another optional implementation of the present invention, the service fee proportion is inversely proportional to an accumulated transaction volume of the shop.

In another optional implementation of the present invention, the first processor 61 is specifically configured to: load the service fee proportion on a pre-set protocol template, and generate an electronic protocol to be signed.

In another optional implementation of the present invention, the first processor 61 is further configured to: when the signing of the electronic protocol is terminated, if the signing of the electronic protocol is started by the client of the seller, generate a shop creation response representing terminating the current signing of the electronic protocol, and send the shop creation response to the client of the seller; and if the signing of the electronic protocol is started by the network transaction platform, generate a transaction failure message representing terminating the order due to being unable to sign the electronic protocol, and send the transaction failure message to the client of the seller.

In addition to providing a secure network transaction method, the embodiments of the present invention further provides a network transaction platform. Please refer to FIG. 8. FIG. 8 shows a structural block diagram of a service fee platform according to an embodiment of the present invention. The service fee platform 80 comprises a second processor 81; and

the second processor 81 is configured to: store service fees of all network transactions transferred via the network transaction platform to constitute a compensation capital pool; and when the buyer initiates a claim for compensation with regard to a network transaction, extract a compensation capital of the network transaction from the compensation capital pool and transfer same to a buyer account, wherein the service fee of the network transaction is a part of fee deducted from a transaction fund of the network transaction, and the remaining transaction fund after the service fee has been deducted is transferred to a seller account.

In the technical solutions of the present invention, the service fee platform is able to provide a rights protection channel and compensation for the buyer on the network transaction platform, and once an infringement behavior occurs, the buyer may also obtain a compensation capital equal to or greater than the transaction fund from the service fee platform without claiming for compensation from the seller, which is helpful to improve the convenience and reliability of rights protection and compensation of the buyer. In addition, the network transaction platform in the present invention is different from means of consumption insurance, etc. on other network transaction platforms, and the means of consumption insurance, etc. need the buyer to additionally pay an insurance fee, which increases a shopping burden of the buyer. However, the present invention does not need the buyer to additionally pay the insurance fee, but deducts a part of service fee from the transaction fund of each network transaction as a source of compensation capital. In addition, the service fee platform in the present invention is also different from a self-operation mode of other network transaction platforms. In the self-operation mode, the network transaction platform needs to bear the liability for breach of contract, while in fact the difficulty for the buyer to fight against a large-scale network transaction platform and perform rights protection is relatively large. The service fee platform of the present invention may be managed by an operator different from that of the network transaction platform, and provide safeguard for the buyer as a fair third party, and the processing process is fair, open, effective and in time.

Furthermore, the present invention can achieve automation of signing an electronic protocol to the maximum degree, and can perform different processing procedures with regard to a new shop and an old shop. Moreover, when the network transaction platform signs the electronic protocol with a large number of shops, the signing time points may be dispersed according to the solution of the present invention, which avoids processing a large amount of data work within a short time by the network transaction platform, reduces an instantaneous load of the transaction platform server, and reduces the total data processing volume of the network transaction platform as much as possible.

It should be noted that, persons of ordinary skill in the art should understand that, all or a part of procedures in the methods of the above embodiments may be accomplished by a computer program instructing relevant hardware. The program may be stored in a computer-readable storage medium. When the program is executed, the procedures of the methods of the embodiments may be performed, wherein the storage medium may be a magnetic disk, an optical disc, a read-only memory (Read-Only Memory, ROM), a random access memory (Random Access Memory, RAM), or the like.

The secure network transaction method, network transaction platform and service fee platform that are provided in the present invention are introduced in detail in the foregoing. In this document, specific embodiments are used for illustrating principles and implementation manners of the present invention. The foregoing descriptions of the embodiments are merely used to help understand the method and core idea of the present invention. Meanwhile, based on the conception of the present invention, changes will be made on either the specific implementations or the application scopes by those of ordinary skill in the art. Above all, the content of the present description shall not be understood as limitation on the present invention.

1. A secure network transaction method, characterized by comprising:
when a buyer and a seller conduct a network transaction via a network transaction platform, the network transaction platform deducting a part of fee from a transaction fund of the network transaction as a service fee of the network transaction, transferring the remaining transaction fund after the service fee has been deducted to a seller account, and transferring the service fee of the network transaction to a service fee platform; service fees of all network transactions conducted on the network transaction platform constituting a compensation capital pool on the service fee platform; and
when the buyer initiates a claim for compensation with regard to the network transaction, the service fee platform extracting a compensation capital of the network transaction from the compensation capital pool and transferring same to a buyer account.

2. The method according to claim 1, characterized in that the compensation capital of the network transaction is N times of the transaction fund of the network transaction, N being a positive integer.

3. The method according to claim 1, characterized in that the network transaction platform deducting a part of fee from a transaction fund of the network transaction as a service fee of the network transaction comprises:
the network transaction platform calculating the service fee of the network transaction according to a service fee proportion agreed with the seller, the service fee proportion being a proportion of the service fee to the transaction fund; and
the network transaction platform deducting the service fee of the network transaction from the transaction fund of the network transaction.

4. The method according to claim 3, characterized in that the service fee proportion is a fixed proportion.

5. The method according to claim 4, characterized in that the service fee proportion is 0%-8%.

6. The method according to claim 5, characterized in that the service fee proportion is 3%.

7. The method according to claim 3, characterized in that the service fee proportion is obtained through calculation of the network transaction platform according to at least one service fee-related item relevant to calculating the service fee proportion in shop information about the seller.

8. The method according to claim 7, characterized in that the service fee proportion is inversely proportional to an accumulated transaction volume in the shop information.

9. The method according to claim 1, characterized in that the network transaction platform and the service fee platform are platforms independent from each other and managed by different operators.

10. The method according to claim 1, characterized in that the method further comprises:
before the network transaction platform deducting a part of fee from a transaction fund of the network transaction as a service fee of the network transaction, the network transaction platform signing an electronic protocol with a client of the seller, wherein the electronic protocol comprises agreement relevant to the service fee.

11. A network transaction platform, characterized in that the network transaction platform comprises a first processor;
the first processor being configured to: when a buyer and a seller conduct a network transaction via the network transaction platform, deduct a part of fee from a transaction fund of the network transaction as a service fee of the network transaction, transfer the remaining transaction fund after the service fee has been deducted to a seller account, and transfer the service fee of the network transaction to a service fee platform, service fees of all network transactions conducted on the network transaction platform constituting a compensation capital pool on the service fee platform, wherein when the buyer initiates a claim for compensation with regard to the network transaction, a part of capital in the compensation capital pool is transferred to a buyer account as a compensation capital of the network transaction.

12. A service fee platform, characterized in that the service fee platform comprises a second processor;
the second processor being configured to: store service fees of all network transactions transferred via the network transaction platform to constitute a compensation capital pool; and when the buyer initiates a claim for compensation with regard to a network transaction, extract a compensation capital of the network transaction from the compensation capital pool and transfer same to a buyer account, wherein the service fee of the network transaction is a part of fee deducted from a transaction fund of the network transaction, and the remaining transaction fund after the service fee has been deducted is transferred to a seller account.
